(19) United States
(12) Patent Application Publication
(10) Pub. No.: US 2014/0291133 A1
(43) Pub. Date: Oct. 2, 2014

(54) KEYCAP STRUCTURE OF A BUTTON AND METHOD OF MAKING THEREOF

(71) Applicant: INHON INTERNATIONAL CORP., LTD., Taipei City (TW)

(72) Inventors: Sih-Ren Fu, Taipei City (TW); Kun-Huang Hsu, Taipei City (TW); Wei-Huan Chou, Taipei City (TW)

(73) Assignee: INHON INTERNATIONAL CORP., LTD., Taipei City (TW)

(21) Appl. No.: 14/220,000

(22) Filed: Mar. 19, 2014

(30) Foreign Application Priority Data
Mar. 29, 2013 (TW) 102205916

(51) Int. Cl. H01H 13/50

(52) U.S. Cl. CPC H01H 13/50
USPC 200/341; 29/428

(57) ABSTRACT

A keycap structure of a button includes a cap body, a plurality of clamping members and a covering member. The cap body is made of metal and has a first surface and a second surface. The covering member is disposed on the first surface. Each clamping member is connected to the second surface. A plurality of breaches is opened on the cap body, so that the breaches are disposed between the first surface and the second surface. Each breach is connected with each corresponding clamping member. Under this arrangement, since the cap body is made of metal, the thickness of the cap body is reduced while retaining mechanical strength; additionally, the total weight of the keycap structure of a button is reduced due to the breaches. Consequently, upon assembling the keycap structure of a button, a lighter and thinner keyboard or laptop is provided.

### CROSS-REFERENCES TO RELATED APPLICATIONS

This non-provisional application claims priority under 35 U.S.C. §119(a) to TW Patent Application No. 102205916 filed in Taiwan, R.O.C. on Mar. 29, 2013, the entire contents of which are hereby incorporated by reference.

### FIELD

The present invention relates to a button, and particularly to a keycap structure of a button.

### BACKGROUND

Weights and sizes of laptops (such as notebooks and ultrabooks) are reduced for users' conveniences and feelings when carrying the devices with them.

A keyboard is a basic element for a laptop, wherein a plurality of keycaps is disposed on the keyboard and corresponds to texts or symbols respectively. As shown in FIG. 1, a partial lateral-sectional view of a conventional keyboard is provided. The conventional keyboard has a base 90, a plurality of keycaps 91 and a plurality of linking-up bars 92 which are disposed between the base and the keycaps. First fixing portions 901 and second fixing portions 911 are assembled on the base 90 and the keycaps 91 and correspond to each other respectively, wherein two ends of each linking-up bar 92 is fixed with each corresponding first fixing portion 901 and each corresponding second fixing portion 911. Therefore, when a user presses the keycap 91, the keycap 91 is moved toward the base and further contacted with the base, so that a signal corresponding to the text of the keycap 91 is sent to a processor of the laptop for inputting information. When the user releases the keycap 91, the keycap 91 is moved back via corresponding linking-up bars so as to be pressed again.

Generally, the number of the keycaps on the laptop is high. Therefore, in order to reduce the weight of the laptop, the keycaps are made of plastic materials and the thicknesses of the keycaps are attenuated.

However, once the thicknesses of the plastic keycaps are attenuated significantly, the mechanical strength of the plastic keycaps is also greatly reduced, due to the mechanical properties of plastic materials, so the keycaps are easily damaged.

### SUMMARY

In view of this, the present invention proposes a keycap structure of a button, wherein the thickness and the weight of the keycap structure of a button are reduced significantly with the mechanical strength retaining enough for support, so that the keycap structure of a button is not damaged easily.

The keycap structure of a button has a cap body, a plurality of clamping members and a covering member. The cap body is made of metal and has a first surface and a second surface. Each clamping member is connected to the second surface and is formed after punching and bending the cap body. The first surface is covered with the covering member so as to cover breaches of the cap body.

A method for manufacturing the aforementioned invention further proposes a keycap structure of a button. The manufacturing method includes forming a cap body made of metal in which the cap body has a first surface and a second surface, which is opposite to the first surface. Furthermore, the cap body is punched to form a plurality of breaches, bended form a plurality of clamping members, and then the first surface of the cap body is covered with a covering member to cover the breaches of the cap body.

Based on the above, the keycap structure of a button provides enough mechanical strength even when the thickness of the keycap structure of a button is reduced significantly due to the metal cap body. In addition, since the clamping members are integrally formed on the cap body via punching and bending the cap body, there is no need to provide extra components for clamping, further reducing the weight of the cap body. Under this arrangement, electronic devices assembled with the present invention are lighter and thinner and can be carried more conveniently as compared to conventional devices.

The detailed features and advantages of the present invention are described below in great detail through the following embodiments, the content of the detailed description is sufficient for those skilled in the art to understand the technical content of the present invention and to implement the present invention there accordingly. Based on the content of the specification, the claims, and the drawings, those skilled in the art can easily understand the relevant objectives and advantages of the present invention.

### BRIEF DESCRIPTION OF THE DRAWINGS

The present invention will become more fully understood from the detailed description given herein below for illustration only, and thus are not limitative of the present invention, wherein:

FIG. 1 is a partial lateral-sectional view of a conventional button of a keyboard;

FIG. 2 is an exploded view of a keycap structure of a button of the present invention;

FIG. 3 is a bottom view of the keycap structure of a button of the present invention;

FIG. 4 is a lateral sectional view of the keycap structure of a button of the present invention; and

FIG. 5 is another exploded view of the keycap structure of a button of the present invention.

### DETAILED DESCRIPTION

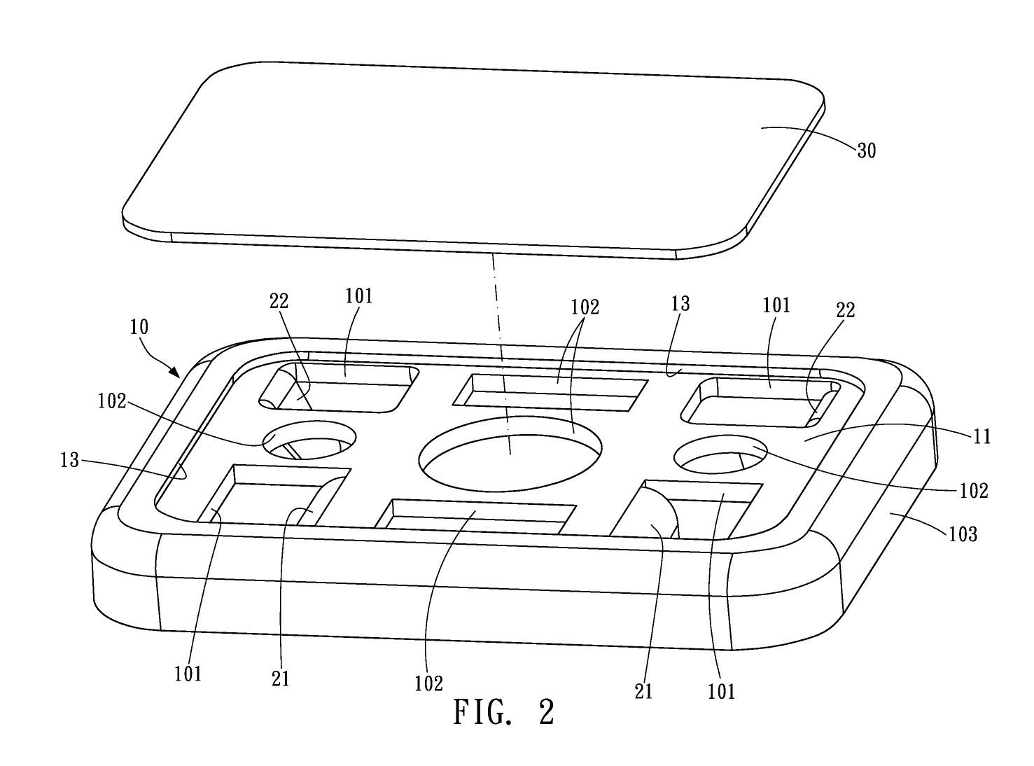

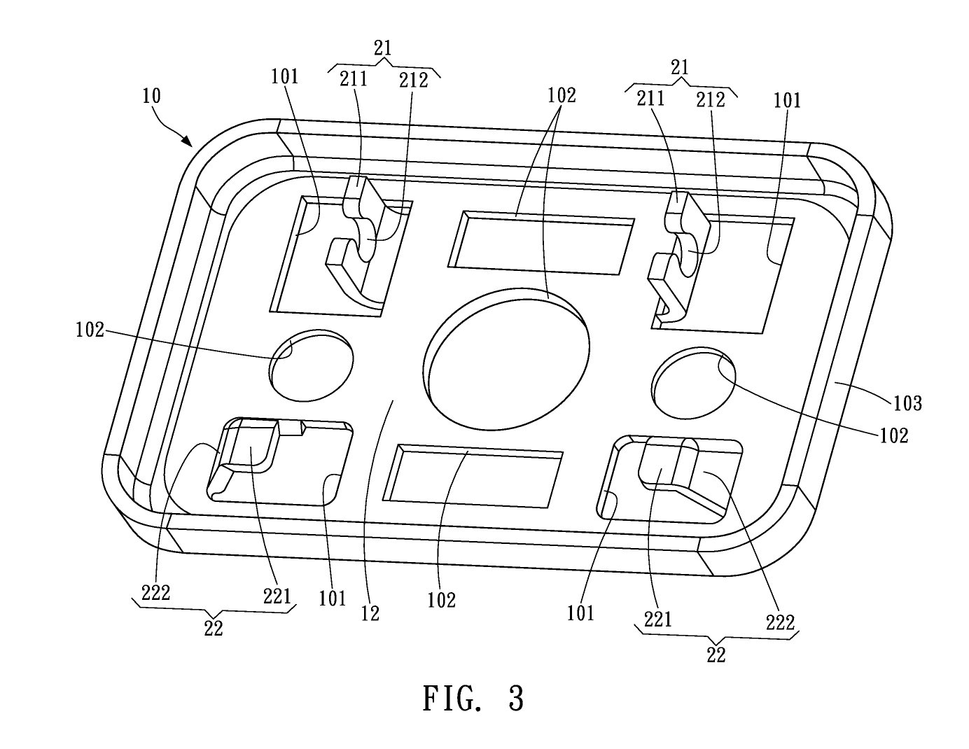

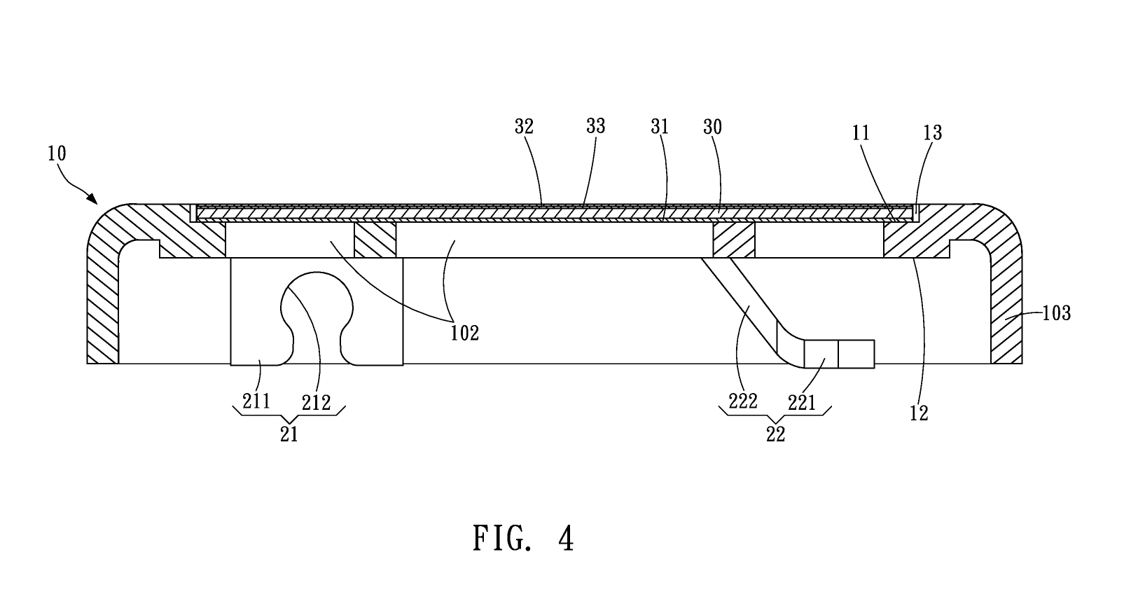

FIG. 2 is an exploded view of a keycap structure of a button, which is applicable to a keyboard, of the present invention. FIG. 3 is a bottom view of the keycap structure of a button of the present invention. FIG. 4 is a lateral sectional view of the keycap structure of a button of the present invention. Please refer to FIG. 2-FIG. 4, in which the keycap structure of a button includes a cap body 10, a plurality of clamping members 21, 22 and a covering member 30.

In this embodiment, the cap body 10, made of metal, includes a first surface 11 and a second surface 12, wherein the first surface 11 is opposite to the second surface 12. The cap body 10 has a plurality of breaches 101. Each breach 101 is disposed between the first surface 11 and the second surface 12, that is to say, two ends of the edge of each breach 101 is connected to the first surface 11 and the second surface 12 respectively.

As shown in FIG. 3, each of the clamping members 21, 22 is connected to the second surface 12. Each breach 101 is connected to each corresponding clamping member 21, 22. In this embodiment, the cap body 10 is punched firstly so as to form the breaches 101 and linking portions which are connected to one ends of the breaches 101; and then, the linking portions are bent or punched so as to form the clamping members 21, 22. For explicitness, the clamping members 21, 22 are further classified as first clamping members 21 and second clamping members 22. Please refer to FIG. 3, in which the first clamping members 21 are disposed at two sides of the cap body 10 symmetrically; similarly, the second clamping members 22 are disposed at two sides of the cap body 10 symmetrically. For instance, in one embodiment, two first clamping members 21 are disposed at the upper part of the second surface 12 and located at the two sides of the cap body 10 respectively, and the two second clamping members 22 are disposed at the lower part of the second surface 12 and located at the two sides of the cap body 10 respectively.

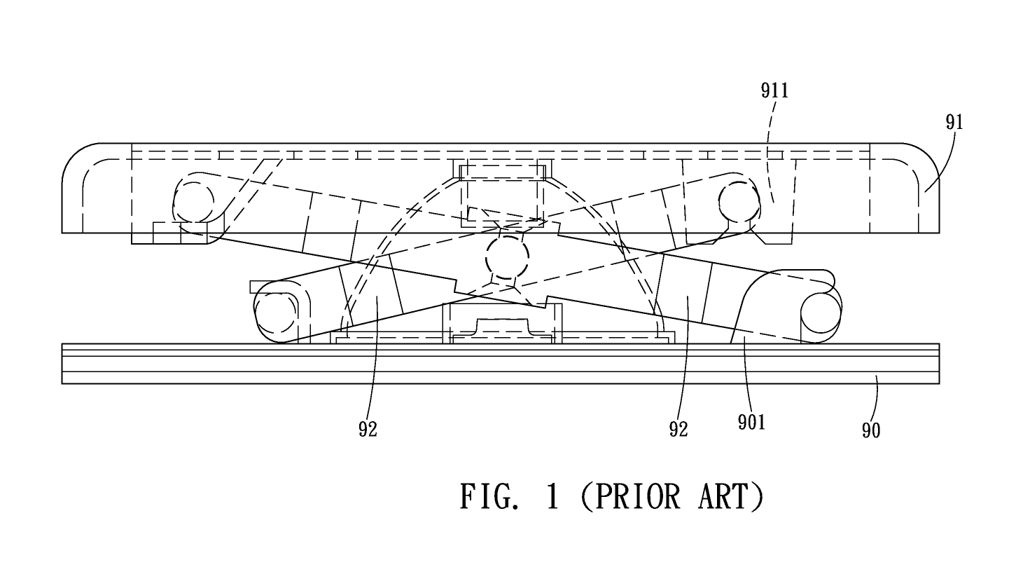

Each first clamping member 21 has a first clamping body 211 and a clamping hole 212. The clamping hole 212 is opened on the first clamping body 211. Each second clamping member 22 has a second clamping body 221 and a connecting portion 222. The connecting portion 222 is provided to connect the second clamping body 221 and the cap body 10. In this embodiment, each second clamping body 221 is parallel to the second surface 12 of the cap body 10. Particularly, each clamping hole 212 and each second clamping body 221 are connected with a crossed support frame, similar to the structure illustrated in FIG. 1, which is disposed on a base 90 of a keyboard, so that when a user releases the cap body 10, the cap body 10 moves to an original position resiliently.

As shown in FIG. 2 and FIG. 4, the covering member 30 is located on the first surface 11 of the cap body 10. The covering member 30 is provided to cover the breach 101 on the cap body 10. In this embodiment, the covering member 30 and one side of the first surface 11 are connected with an adhesive layer 31 disposed, so that the covering member 30 is securely pasted onto the first surface 11. The application of the adhesive layer 31 is accomplished with a double-sided tape or via an adhesive dripping method. Furthermore, the covering member 30 is made of Mylar and has a decorative layer 32 disposed thereon. In one embodiment, the decorative layer 32 is a polishing layer or an embossing layer, so that the covering member 30 has embossing features, texturing features or a polishing surface. However, embodiments of the present invention are not limited thereto. In some embodiments, the covering member 30 is made of metal, such as Aluminum (Al), Magnesium-Lithium alloys (Mg—Li alloys), other metal or other alloys. In addition, the covering member 30 further has a printed layer 33 so as to print texts or picture thereon. The printed layer 33 is provided to recognize the input texts or improve the beauty of the cap body 10.

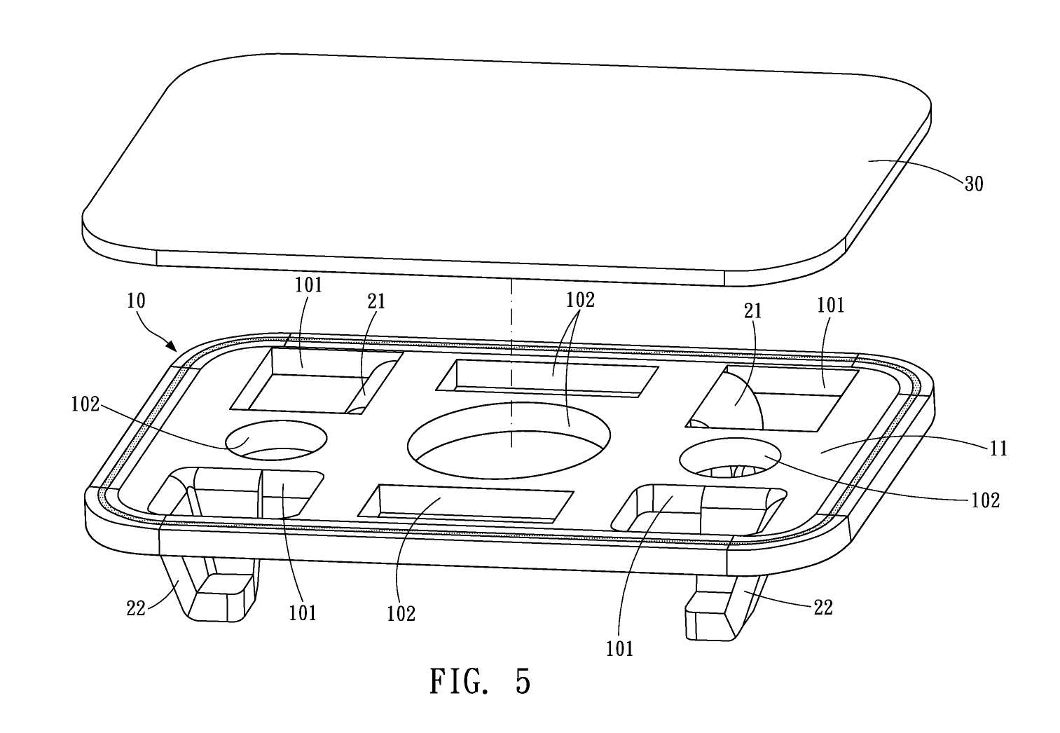

As shown in FIG. 2 and FIG. 4, in this embodiment, the cap body 10 has an extending portion 103 disposed around the outer periphery thereof and the extending direction of the extending portion 103 is the same as that of the clamping members 21, 22. That is to say, the extending portion 103 is extended far from the first surface 11. But embodiments of the present invention are not limited thereto. In some embodiments, the cap body 10 does not have the extending portion 103, as shown in FIG. 5, so as to reduce the weight of the cap body 10. Additionally, please refer to FIG. 2, in which the cap body 10 has a plurality of lightening holes 102 disposed on the periphery of the breaches 101 respectively. As a result of the lightening holes 102, the weight of the cap body 10 is reduced, so that the total weight of the electronic device assembled with the present invention is also reduced. The shape of the lightening hole 102 can be rounded, but embodiments of the present invention are not limited thereto; the lightening hole 102 is rectangular shaped or other shaped.

In this embodiment, as shown in FIG. 4, the first surface 11 of the cap body 10 further has a positioning groove 13. The positioning groove 13 is provided for receiving and positioning the covering member 30. The positioning groove 13 is extended corresponding to the outer periphery of the covering member 30. The depth of the positioning groove 13 is substantially equal to the thickness of the covering member 30, so that when the covering member 30 is disposed onto the cap body 10, no height difference is existed between the covering member 10 and the first surface 11 of the cap body 10.

According to the keycap structure of a button described above, embodied samples are provided via applying the materials and parameters thereof in the following table:

| | Plastic | | Stainless steel | | Aluminum | | Mg—Li alloys | |
|---|---|---|---|---|---|---|---|---|
| Density | 1.2 | g/cm³ | 7.9 | g/cm³ | 2.7 | g/cm³ | 1.6 | g/cm³ |
| Thickness | 0.7 | mm | 0.45 | mm | 0.45 | mm | 0.45 | mm |
| Length × | 12.7 mm × | | 12.7 mm × | | 12.7 mm × | | 12.7 mm × | |
| Width × | 8.8 mm × | | 8.8 mm × | | 8.8 mm × | | 8.8 mm × | |
| Height | 1.4 mm | | 1.4 mm | | 1.4 mm | | 1.4 mm | |
| Total weight | 0.11 | grams | 0.31 | grams | 0.11 | grams | 0.073 | grams |

According to the table shown above, the total weight of the keycap structure of a button manufactured by plastic, such as the copolymer of Polycarbonate (PC) and Acrylonitrile Butadiene Styrene (ABS) which is also applied to the conventional keycap, is only 0.11 grams; though, the keycap structure of a button made of plastic is the thickest, 0.7 mm, as compared to the keycap structures of a button manufactured by other materials in the above table. The thickness of the alumina keycap structure, 0.45 mm, is thinner than the plastic keycap structure of a button, and the total weight of the alumina keycap structure of a button is 0.11 grams, too. The thickness of the Mg—Li alloys keycap structure of a button is retained at 0.45 mm, and the total weight of the Mg—Li alloys keycap structure of a button is 0.073 grams, which is cut down by 33% as compared to that of the plastic keycap structure of a button. Consequently, when metal materials are applied, not only the thickness of the metal keycap structures of a button is reduced, but also the total weight of the metal keycap structures of a button is retained, or even reduced.

As mentioned above, in one embodiment the cap body 10 is made of metal so that the thickness thereof is reduced while retaining mechanical strength. In addition, the total weight of the keycap structure of a button is significantly reduced due to the breaches 101 and the lightening holes 102. Therefore, a lighter and thinner keycap structure of a button is provided a user to carry a personal computer or a laptop with the aforementioned keyboard humanizedly.

The present invention further provides a manufacturing method for a keycap structure of a button, the step of the manufacturing method includes forming a cap body 10 made of metal in which the cap body 10 has a first surface 11 and a second surface 12 opposite to the first surface 11, punching the cap body 10 to form a plurality of breaches 101, bending the cap body 10 to form a plurality of clamping members 21, 22 in which the clamping members 21, 22 are connected to the second surface 12, and covering the first surface 11 of the cap body 10 with a covering member 30 to cover the breaches 101 of the cap body 10. The detailed features of the manufacturing method can be understood from the descriptions mentioned above and are thus omitted here.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A keycap structure of a button comprising:
a cap body, made of metal, a first surface and a second surface in which the first surface is opposite to the second surface;
a plurality of clamping members, connecting to the second surface, the cap body being punched and bent for forming the clamping members; and
a covering member, covered on the first surface of the cap body so as to cover breaches of the cap body.

2. The keycap structure of a button according to claim 1, wherein the cap body comprises a plurality of lightening holes disposed on the periphery of the breaches of the cap body.

3. The keycap structure of a button according to claim 1, wherein the cap body comprises a positioning groove for receiving the covering member.

4. The keycap structure of a button according to claim 1, wherein an extending portion is connected to an outer periphery of the cap body, the extending direction of the extending portion is the same as that of the clamping members.

5. The keycap structure of a button according to claim 1, wherein an adhesive layer is provided to paste the covering member onto the cap body.

6. The keycap structure of a button according to claim 1, wherein the clamping members comprise a plurality of first clamping members and a plurality of second clamping members, the first clamping members are disposed at two sides of the cap body symmetrically, the second clamping members are disposed at the two sides of the cap body symmetrically.

7. The keycap structure of a button according to claim 6, wherein each first clamping member comprises a first clamping body and a clamping hole, the clamping hole is opened on the first clamping body.

8. The keycap structure of a button according to claim 6, wherein each second clamping member comprises a second clamping body and a connecting portion, the connecting portion is connected to the second clamping body and the cap body, each second clamping body is substantially parallel to the cap body.

9. The keycap structure of a button according to claim 1, wherein the covering member comprises a printed layer.

10. The keycap structure of a button according to claim 1, wherein the covering member is made of metal and comprises a decorative layer, the decorative layer is a polishing layer or an embossing layer.

11. A manufacturing method for a keycap structure of a button, comprising:
forming a cap body which is made of metal, the cap body comprising a first surface and a second surface in which the first surface is opposite to the second surface;
punching the cap body to form a plurality of breaches;
bending the cap body to form a plurality of clamping members in which the clamping members are connected to the second surface; and
covering the first surface of the cap body with a covering member to cover the breaches of the cap body.

12. The manufacturing method for a keycap structure of a button according to claim 11, wherein the step of punching the cap body to form the breaches further comprises step of forming a plurality of lightening holes on the cap body in which the lightening holes are disposed on the periphery of the breaches.

13. The manufacturing method for a keycap structure of a button according to claim 11, wherein the step of punching the cap body to form the breaches further comprises step of forming a positioning groove on the cap body in which the positioning groove is provided for receiving the covering member.

14. The manufacturing method for a keycap structure of a button according to claim 11, wherein the step of punching the cap body to form the breaches further comprises the step of forming an extending portion on an outer periphery of the cap body, and the extending direction of the extending portion is the same as that of the clamping members.

15. The manufacturing method for a keycap structure of a button according to claim 11, wherein the step of covering the first surface of the cap body with a covering member further comprises the step of providing an adhesive layer to paste the covering member onto the cap body.

16. The manufacturing method for a keycap structure of a button according to claim 11, wherein in the step of bending the cap body to form the breaches, the clamping members comprises a plurality of first clamping members and a plurality of second clamping members, the first clamping member are disposed at two sides of the cap body symmetrically, and the second clamping members are disposed at the two sides of the cap body symmetrically.

17. The manufacturing method for a keycap structure of a button according to claim 16, wherein in the step of bending the cap body to form the breaches, each first clamping member comprises a first clamping body and a clamping hole, and the clamping hole is opened on the first clamping body.

18. The manufacturing method for a keycap structure of a button according to claim 16, wherein in the step of bending the cap body to form the breaches, each second clamping member comprises a second clamping body and a connecting portion, the connecting portion is connected to the second clamping body and the cap body, and each second clamping body is substantially parallel to the cap body.

19. The manufacturing method for a keycap structure of a button according to claim 11, wherein the step of covering the first surface of the cap body with a covering member further comprises step of printing the covering member to form a printed layer.

20. The manufacturing method for a keycap structure of a button according to claim 11, wherein in the step of covering the first surface of the cap body with a covering member, the covering member is made of metal and comprises a decorative layer, and the decorative layer is a polishing layer or an embossing layer.
